(19) United States
(12) Patent Application Publication
(10) Pub. No.: US 2015/0341827 A1
(43) Pub. Date: Nov. 26, 2015

(54) METHOD AND ELECTRONIC DEVICE FOR MANAGING DATA FLOW

(71) Applicant: Samsung Electronics Co., Ltd., Gyeonggi-do (KR)

(72) Inventors: Moongyo BAE, Gyeonggi-do (KR); Myungsu Kang, Seoul (KR); Jungwoo Lee, Gyeonggi-do (KR); Soonhyun Cha, Gyeonggi-do (KR); Sunmin Hwang, Gyeonggi-do (KR)

(73) Assignee: Samsung Electronics Co., Ltd.

(21) Appl. No.: 14/717,479

(22) Filed: May 20, 2015

(30) Foreign Application Priority Data
May 20, 2014 (KR) 10-2014-0060370

(51) Int. Cl. H04W 28/10; H04W 28/02

(52) U.S. Cl. CPC H04W 28/10; H04W 28/0236; H04W 28/0289

(57) ABSTRACT

An apparatus and a method of managing a data flow in an electronic device is provided. The method includes monitoring a tethering including monitoring a tethering state using a first data flow connected to a first backhaul in a tethering group, determining whether a new data flow is added according to the monitored tethering state, selecting an auxiliary terminal including a second backhaul from among one or more terminals in the tethering group and generating a second data flow connected to the second backhaul, and configuring one of the first data flow and the second data flow according to the tethering state and a state of data that is to be transmitted through one of the first data flow and the second data flow.

### PRIORITY

This application claims priority under 35 U.S.C. §119(a) to Korean Patent Application Serial No. 10-2014-0060370, which was filed in the Korean Intellectual Property Office on May 20, 2014, the entire disclosure of which is incorporated herein by reference.

### BACKGROUND OF THE INVENTION

1. Field of the Invention

The present invention relates generally to a method of managing a data flow of an electronic device, and more particularly, to a device that is configured to use a method of managing data flow in a tethering, which may manage a flow of data in tethering a group including a plurality of terminals.

2. Description of the Related Art

A tethering service is a service enabling terminals, which cannot connect to a communication network, to use a service, such as an internet service, by accessing the communication network using a terminal which can connect to the communication network through a 3Generation (3G) or a 2G standard. In addition, recently, the tethering service has also been used so that a plurality of terminals can simultaneously receive a service, such as a network game.

Conventionally, only a network (i.e., a backhaul) of only one terminal, to which a plurality of terminals is connected, is used during such a tethering service. In this case, data performance provided to each terminal is limited, and a user may be inconvenienced. In addition, the terminal providing the tethering service typically does not manage data, i.e., the terminal merely performs a bypass on the data. Therefore, other terminals connected to the terminal providing the tethering service are dependent on a speed of a network to which the terminal providing the tethering service is connected and synergy through a mutual data network sharing may not be obtained. Accordingly, speed and performance of all terminals forming a tethering group are degraded, and thus the user may feel inconvenienced by using such a tethering group.

### SUMMARY OF THE INVENTION

The present invention has been made to address at least the above mentioned problems and/or disadvantages and to provide at least the advantages described below.

In accordance with an aspect of the present invention, a method of managing a data flow in an electronic device is provided. The method includes monitoring a tethering including monitoring a tethering state using a first data flow connected to a first backhaul in a tethering group, determining whether a new data flow is added according to the monitored tethering state, selecting an auxiliary terminal including a second backhaul from among one or more terminals in the tethering group and generating a second data flow connected to the second backhaul, and configuring one of the first data flow and the second data flow according to the tethering state and a state of data that is to be transmitted through one of the first data flow and the second data flow.

In accordance with an aspect of the present invention, an electronic device is provided. The electronic device includes a data transmitting and receiving module that transmits and receives data to and from an external network according to a first data flow connected to a first backhaul and a control module that transfers data transmitted from a data flow managing module to the data transmitting and receiving module, classifies the data transmitted from the data transmitting and receiving module according to requests by each terminal in a tethering group and transmits the classified data to the data flow managing module. The data flow managing module monitors a tethering state in the tethering group, selects an auxiliary terminal including a second backhaul according to a monitored result of the tethering state to generate a second data flow connected to the second backhaul and configures one of the first data flow and the second data flow according to the tethering state and a state of data that is to be transmitted through one of the first data flow and the second data flow.

In accordance with another aspect of the present invention, a computer readable recording medium in which at least one program including instructions for performing a method of managing a data flow is recorded is provided. The method includes monitoring a tethering including monitoring a tethering state using a first data flow connected to a first backhaul in a tethering group, determining whether a new data flow is added according to the monitored tethering state, selecting an auxiliary terminal including a second backhaul from among one or more terminals in the tethering group and generating a second data flow connected to the second backhaul, and configuring one of the first data flow and the second data flow according to the tethering state and a state of data that is to be transmitted through one of the first data flow and the second data flow.

According to an aspect of the present invention, an electronic device which uses a method of managing a data flow is provided, such that when a tethering group is formed, a data transmission speed can be improved and resources can be effectively utilized by managing a data flow.

According to an aspect of the present invention, an electronic device which uses a method of managing a data flow is provided, such that additional data flow can be generated according to a tethering state of a tethering group.

According to an aspect of the present invention, an electronic device which uses a method of managing a data flow is provided, such that data can be processed faster and more effectively by differently configuring data flows corresponding to each piece of data.

### BRIEF DESCRIPTION OF THE DRAWINGS

The above and other aspects, features and advantages of the present invention will be more apparent from the following detailed description in conjunction with the accompanying drawings, in which:

FIG. 1 is a block diagram illustrating a network environment including an electronic device, according to an embodiment of the present invention;

FIG. 2 is a block diagram of an electronic device and a tethering group, according to an embodiment of the present invention;

FIG. 3 is a diagram illustrating a configuration of an electronic device and a tethering group, according to an embodiment of the present invention;

FIG. 4A and FIG. 4B are diagrams illustrating an operation of an electronic device, according to an embodiment of the present invention;

FIG. 5 is a diagram illustrating a table for configuring a data flow, according to an embodiment of the present invention;

FIG. 6 is a flowchart illustrating a method of a managing a data flow, according to an embodiment of the present invention;

FIG. 7 is a flowchart illustrating an operation of adding a data flow in a method of managing a data flow, according to an embodiment of the present invention; and

FIG. 8 is a flowchart illustrating an operation of adding the data flow in the method of managing the data flow, according to an embodiment of the present invention.

### DETAILED DESCRIPTION OF THE EMBODIMENTS OF THE PRESENT INVENTION

The following description with reference to the accompanying drawings is provided to assist in a comprehensive understanding of various embodiments of the present invention as defined by the claims and their equivalents. It includes various specific details to assist in the understanding of the present invention, but these are to be regarded as merely examples. Accordingly, those of ordinary skill in the art will recognize that various changes and modifications of the embodiments described herein can be made without departing from the scope and spirit of the present invention. In addition, descriptions of well-known functions and constructions may be omitted for clarity and conciseness.

The terms and words used in the following description and claims are not limited to their dictionary meanings, but, are merely used to enable a clear and consistent understanding of the present invention. Accordingly, it should be apparent to those skilled in the art that the following description of various embodiments of the present invention is provided for illustration purposes only and not for the purpose of limiting the present invention as defined by the appended claims and their equivalents.

As used herein, the singular forms “a”, “an”, and “the” are intended to include the plural forms, including “at least one”, unless the content clearly indicates otherwise. “Or” means “and/or”. As used herein, the term “and/or” includes any and all combinations of one or more of the associated listed items. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first”, “second”, “third”, etc.

may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element”, “component”, “region”, “layer” or “section” discussed below could be termed a second element, component, region, layer or section without departing from the teachings herein.

As used herein, an electronic device may be a device that involves a communication function. For example, an electronic device may be a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a portable medical device, a digital camera, or a wearable device (e.g., an Head-Mounted Device (HMD) such as electronic glasses, electronic clothes, an electronic bracelet, an electronic necklace, an electronic appcessory, or a smart watch).

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of Application-Specific Integrated Circuit (ASIC) chip, Field-Programmable Gate Arrays (FPGAs), and programmable-logic device, which have been known or are to be developed.

An electronic device may be a smart home appliance that involves a communication function. For example, an electronic device may be a TV, a Digital Video Disk (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

An electronic device may be a medical device (e.g., Magnetic Resonance Angiography (MRA), Magnetic Resonance Imaging (MRI), Computed Tomography (CT), ultrasonography, etc.), a navigation device, a Global Positioning System (GPS) receiver, an Event Data Recorder (EDR), an Flight Data Recorder (FDR), a car infotainment device, electronic equipment for ship (e.g., a marine navigation system, a gyrocompass, etc.), avionics, security equipment, or an industrial or home robot.

An electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are examples only and not to be considered as a limitation of this invention.

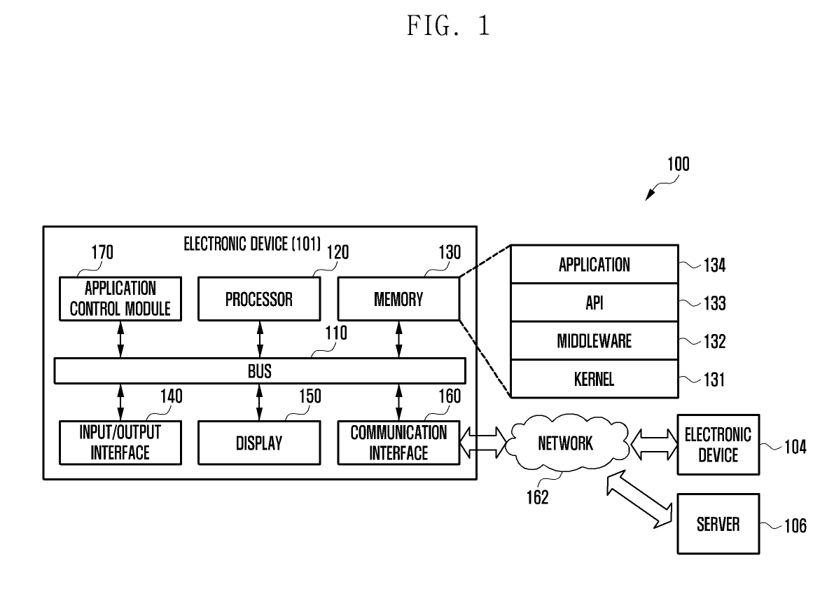

FIG. 1 is a block diagram illustrating a network environment 100 including therein an electronic device 101, according to an embodiment of the present invention. Referring to FIG. 1, the electronic device 101 includes a bus 110, a processor 120, a memory 130, an input/output interface 140, a display 150, a communication interface 160, and an application control module 170.

The bus 110 may be a circuit designed for connecting the above-discussed elements and communicating data (e.g., a control message) between such elements.

The processor 120 receives commands from the other elements (e.g., the memory 130, the input/output interface 140, the display 150, the communication interface 160, or the application control module 170, etc.) through the bus 110, interprets the received commands, and performs the arithmetic or data processing based on the interpreted commands.

The memory 130 stores therein commands or data received from or created at the processor 120 or other elements (e.g., the input/output interface 140, the display 150, the communication interface 160, or the application control module 170, etc.). The memory 130 includes programming modules such as a kernel 131, a middleware 132, an application programming interface (API) 133, and an application 134. Each of the programming modules may be composed of software, firmware, hardware, and any combination thereof.

The kernel 131 controls or manages system resources (e.g., the bus 110, the processor 120, or the memory 130, etc.) used for performing operations or functions of the other programming modules, e.g., the middleware 132, the API 133, or the application 134. Additionally, the kernel 131 offers an interface that allows the middleware 132, the API 133 or the application 134 to access, control or manage individual elements of the electronic device 101.

The middleware 132 performs intermediation by which the API 133 or the application 134 communicates with the kernel 131 to transmit or receive data. Additionally, in connection with task requests received from the applications 134, the middleware 132 performs a control (e.g., scheduling or load balancing) for the task request by using technique such as assigning the priority for using a system resource of the electronic device 101 (e.g., the bus 110, the processor 120, or the memory 130, etc.) to at least one of the applications 134.

The API 133, which is an interface for allowing the application 134 to control a function provided by the kernel 131 or the middleware 132, may include, for example, at least one interface or function (e.g., a command) for a file control, a window control, an image processing, a text control, and the like.

The application 134 includes an SMS/MMS application, an email application, a calendar application, an alarm application, a health care application (e.g., an application for measuring quantity of motion or blood sugar), an environment information application (e.g., an application for offering information about atmospheric pressure, humidity, or temperature, etc.), and the like. Additionally or alternatively, the application 134 may be an application associated with an exchange of information between the electronic device 101 and any external electronic device (e.g., an external electronic device 104). This type application includes a notification relay application for delivering specific information to an external electronic device, or a device management application for managing an external electronic device.

For example, the notification relay application includes a function to deliver notification information created at any other application of the electronic device 101 (e.g., the SMS/MMS application, the email application, the health care application, or the environment information application, etc.) to an external electronic device 104. Additionally or alternatively, the notification relay application receives notification information from an external electronic device 104 and offers it to a user. The device management application manages (e.g., install, remove or update) a certain function (a turn-on/turn-off of an external electronic device (or some components thereof), or an adjustment of brightness (or resolution) of a display) of an external electronic device 104 communicating with the electronic device 101, a certain application operating at such an external electronic device, or a certain service (e.g., a call service or a message service) offered by such an external electronic device.

The application 134 includes a specific application specified depending on attributes (e.g., a type) of an external electronic device 104. For example, in a case when an external electronic device is an MP3 player, the application 134 may include a specific application associated with a play of music. Similarly, in a case when an external electronic device is a portable medical device, the application 134 may include a specific application associated with a healthcare provider. The application 134 includes at least one of an application assigned to the electronic device 101 or an application received from an external electronic device (e.g., the server 106 or the electronic device 104).

The input/output interface 140 delivers commands or data, entered by a user through an input/output unit or module (e.g., a sensor, a keyboard, or a touch screen), to the processor 120, the memory 130, the communication interface 160, or the application control module 170 via the bus 110. For example, the input/output interface 140 may offer data about a user's touch, entered through the touch screen, to the processor 120. Also, through the input/output unit (e.g., a speaker or a display), the input/output interface 140 outputs commands or data, received from the processor 120, the memory 130, the communication interface 160, or the application control module 170 via the bus 110. For example, the input/output interface 140 may output voice data, processed through the processor 120, to a user through the speaker.

The display 150 displays thereon various kinds of information (e.g., multimedia data, text data, etc.) to a user.

The communication interface 160 performs a communication between the electronic device 101 and any external electronic device (e.g., the electronic device 104 of the server 106). For example, the communication interface 160 may communicate with any external device by being connected with a network 162, through a wired or wireless communication. A wireless communication may include, but not limited to, at least one of Wireless Fidelity (WiFi), Bluetooth (BT), Near Field Communication (NFC), Global Positioning System (GPS), or a cellular communication (e.g., LTE, LTE-A, CDMA, WCDMA, UMTS, WiBro, or GSM, etc.). A wired communication may include, but not limited to, at least one of Universal Serial Bus (USB), High Definition Multimedia Interface (HDMI), Recommended Standard 232 (RS-232), or Plain Old Telephone Service (POTS).

The network 162 may be a communication network, which may include at least one of a computer network, an internet, an internet of things, or a telephone network. A protocol (e.g., transport layer protocol, data link layer protocol, or physical layer protocol) for a communication between the electronic device 101 and any external device may be supported by at least one of the application 134, the API 133, the middleware 132, the kernel 131, or the communication interface 160.

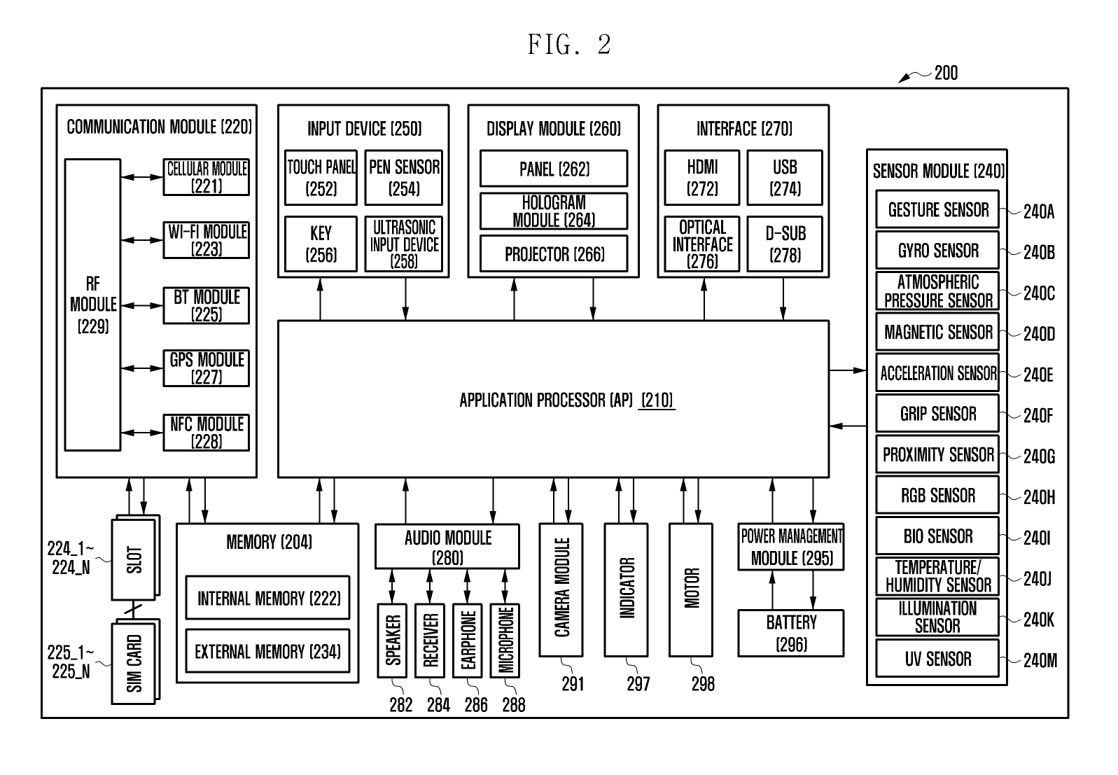

The application control module 170 processes at least part of information obtained from the other elements (e.g., the processor 120, the memory 130, the input/output interface 140, or the communication interface 160, etc.) and then offers it to a user in various ways. For example, the application control module 170 may recognize information about access components equipped in the electronic device 101, store such information in the memory 130, and execute the application 134 on the basis of such information. A further description about the application control module 170 will be described below with reference to FIGS. 2-9.

FIG. 2 is a block diagram illustrating an electronic device 200, according to an embodiment of the present invention. The electronic device 200 may form, for example, the whole or part of the electronic device 101 shown in FIG. 1. Referring to FIG. 2, the electronic device 201 includes at least one application processor (AP) 210, a communication module 220, a subscriber identification module (SIM) card 225_1, a memory 204, a sensor module 240, an input device 250, a display module 260, an interface 270, an audio module 280, a camera module 291, a power management module 295, a battery 296, an indicator 297, and a motor 298.

The AP 210 drives an operating system or applications, controls a plurality of hardware or software components connected thereto, and also performs processing and operation for various data including multimedia data. The AP 210 may be formed of a system-on-chip (SoC), for example. The AP 210 may further include a graphic processing unit (GPU).

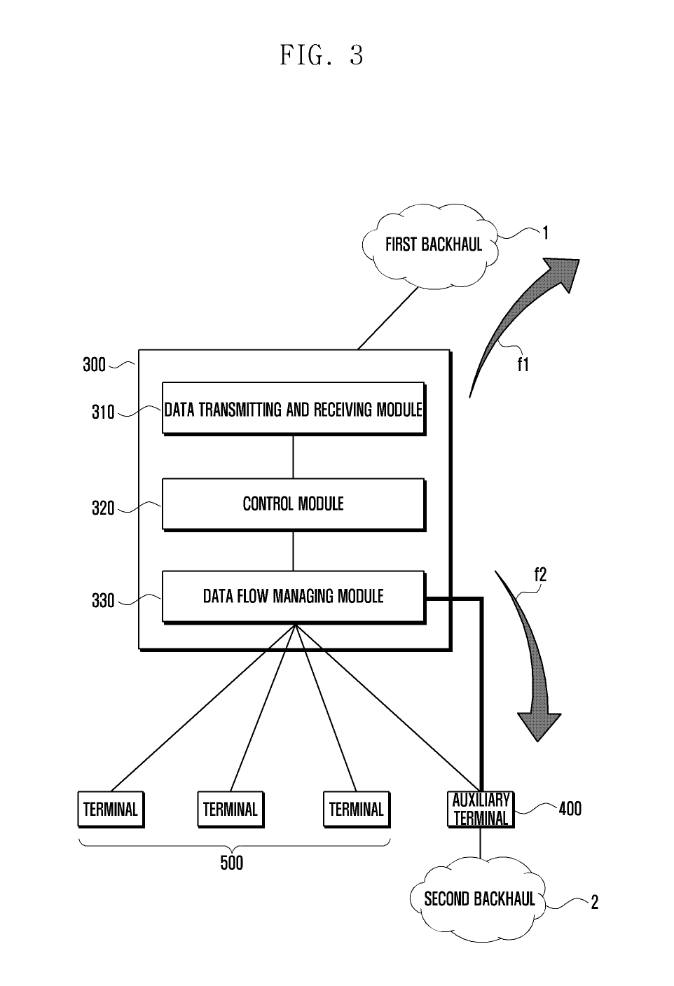

The AP 210 includes a part or a whole of a data transmitting and receiving module 310, a control module 320 and a data flow managing module 330, as shown in FIG. 3.

The communication module 220 (e.g., the communication interface 160) performs a data communication with any other electronic device (e.g., the electronic device 104 or a server 106) connected to the electronic device 200 (e.g., the electronic device 101) through the network. The communication module 220 includes therein a cellular module 221, a WiFi module 223, a BT module 225, a GPS module 227, an NFC module 228, and a Radio Frequency (RF) module 229.

The cellular module 221 offers a voice call, a video call, a message service, an internet service, or the like through a communication network (e.g., LTE, LTE-A, CDMA, WCDMA, UMTS, WiBro, or GSM, etc.). Additionally, the cellular module 221 performs identification and authentication of the electronic device 200 in the communication network, using the SIM card 225_1. The cellular module 221 performs at least part of functions that the AP 210 can provide. For example, the cellular module 221 performs at least part of a multimedia control function.

The cellular module 221 includes a communication processor (CP). Additionally, the cellular module 221 may be formed of SoC, for example. Although some elements such as the cellular module 221 (e.g., the CP), the memory 230, or the power management module 295 are shown as separate elements being different from the AP 210 in FIG. 2, the AP 210 may be formed to have at least part (e.g., the cellular module 221) of the above elements therein.

The AP 210 or the cellular module 221 (e.g., the CP) loads commands or data, received from a nonvolatile memory connected thereto or from at least one of the other elements, into a volatile memory to process them. Additionally, the AP 210 or the cellular module 221 stores data received from or created at one or more of the other elements in the nonvolatile memory.

Each of the WiFi module 223, the BT module 225, the GPS module 227 and the NFC module 228 includes a processor for processing data transmitted or received therethrough. Although FIG. 2 shows the cellular module 221, the WiFi module 223, the BT module 225, the GPS module 227 and the NFC module 228 as different blocks, at least part of them may be contained in a single Integrated Circuit (IC) chip or a single IC package. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 transmits and receives data, e.g., RF signals or any other electric signals. Although not shown, the RF module 229 may include a transceiver, a Power Amp Module (PAM), a frequency filter, a Low Noise Amplifier (LNA), or the like. Also, the RF module 229 may include any component, e.g., a wire or a conductor, for transmission of electromagnetic waves in a free air space. Although FIG. 2 shows that the cellular module 221, the WiFi module 223, the BT module 225, the GPS module 227 and the NFC module 228 share the RF module 229, at least one of them may perform transmission and reception of RF signals through a different or separate RF module.

The SIM card 225_1 to 225_N may be inserted into a corresponding slot 224_1 to 224_N formed at a certain place of the electronic device 200. The SIM card 225_1 to 225_N may contain therein an Integrated Circuit Card IDentifier (ICCID) or an International Mobile Subscriber Identity (IMSI).

The memory 230 (e.g., the memory 130) includes an internal memory 222 and an external memory 234. The internal memory 222 may include, for example, at least one of a volatile memory (e.g., Dynamic RAM (DRAM), Static RAM (SRAM), Synchronous DRAM (SDRAM), etc.) or a nonvolatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, NOR flash memory, etc.).

The internal memory 222 may have the form of an Solid State Drive (SSD). The external memory 234 may include a flash drive, e.g., Compact Flash (CF), Secure Digital (SD), Micro Secure Digital (Micro-SD), Mini Secure Digital (Mini-SD), eXtreme Digital (Xd), memory stick, or the like. The external memory 234 may be functionally connected to the electronic device 200 through various interfaces. The electronic device 200 may further include a storage device or medium such as a hard drive.

The sensor module 240 measures physical quantity or senses an operating status of the electronic device 200 and convert measured or sensed information into electric signals. The sensor module 240 includes, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., Red, Green, Blue (RGB) sensor), a biometric sensor 240I, a temperature-humidity sensor 240J, an illumination sensor 240K, and a ultraviolet (UV) sensor 240M. Additionally or alternatively, the sensor module 240 may include, e.g., an E-nose sensor, an electromyography (EMG) sensor, an electroencephalogram (EEG) sensor, an electrocardiogram (ECG) sensor, an infrared (IR) sensor, an iris scan sensor, or a finger scan sensor. Also, the sensor module 240 may include a control circuit for controlling one or more sensors equipped therein.

The input device 250 includes a touch panel 252, a digital pen sensor 254, a key 256, and an ultrasonic input unit 258. The touch panel 252 recognizes a touch input in a manner of capacitive type, resistive type, infrared type, or ultrasonic type. Also, the touch panel 252 may further include a control circuit. In case of a capacitive type, a physical contact or proximity of an input device, e.g., a finger or stylus, may be recognized. The touch panel 252 may further include a tactile layer. In this case, the touch panel 252 may offer tactile feedback to a user.

The digital pen sensor 254 may be configured to receive a touch input or use a separate recognition sheet. The key 256 may include, for example, a physical button, an optical key, or a keypad.

The ultrasonic input unit 258 is capable of identifying data by sensing sound waves with a microphone 288 of the electronic device 200, through an input tool that generates ultrasonic signals, thus allowing wireless recognition. The electronic device 200 receives a user input from any external device (e.g., a computer or a server) connected thereto through the communication module 220.

The display module 260 (e.g., the display 150) includes a panel 262, a hologram module 264, and a projector 266. The panel 262 may be, for example, Liquid Crystal Display (LCD), Active Matrix Organic Light Emitting Diode (AM-OLED), or the like. The panel 262 may be flexible, transparent or wearable. The panel 262 may be a single module included with the touch panel 252. The hologram module 264 shows a stereoscopic image in the air using interference of light. The projector 266 projects an image onto a screen, which may be located inside or outside of the electronic device 200. The display 260 may further include a control circuit for controlling the panel 262, the hologram 264, and the projector 266.

The interface 270 includes, for example, a High-Definition Multimedia Interface (HDMI) 272, a Universal Serial Bus (USB) 274, an optical interface 276, or a D-subminiature (D-sub) 278. The interface 270 may be contained, for example, in the communication interface 160, as shown in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) interface.

The audio module 280 performs a conversion between sounds and electric signals. At least part of the audio module 280 may be contained, for example, in the input/output interface 140, as shown in FIG. 1. The audio module 280 processes sound information inputted or outputted through a speaker 282, a receiver 284, an earphone 286, or a microphone 288.

The camera module 291 is a device capable of obtaining still images and moving images. The camera module 291 includes at least one image sensor (e.g., a front sensor or a rear sensor), a lens, an Image Signal Processor (ISP), or a flash (e.g., LED or xenon lamp, not shown).

The power management module 295 manages electric power of the electronic device 200. Although not shown, the power management module 295 may include, for example, a Power Management Integrated Circuit (PMIC), a charger IC, or a battery gauge.

The PMIC may be formed, for example, of an IC chip or SoC. Charging may be performed in a wired or wireless manner. The charger IC may charge a battery 296 and prevent overvoltage or overcurrent from a charger. The charger IC may be used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge measures the amount of charge of the battery 296 and a voltage, current or temperature in a charging process. The battery 296 stores or creates electric power therein and supplies electric power to the electronic device 200. The battery 296 may be, for example, a rechargeable battery or a solar battery.

The indicator 297 may show thereon a current status (e.g., a booting status, a message status, or a recharging status) of the electronic device 200 or one of its components (e.g., the AP 210). The motor 298 converts an electric signal into a mechanical vibration. Although not shown, the electronic device 200 may include a specific processor (e.g., GPU) for supporting a mobile TV. This processor may process media data that comply with standards of Digital Multimedia Broadcasting (DMB), Digital Video Broadcasting (DVB), or media flow.

Each of the above-discussed elements of the electronic device 200 disclosed herein may be formed of one or more components, and its name may be varied according to the type of the electronic device 200. The electronic device 200 disclosed herein may be formed of at least one of the above-discussed elements without some elements or with additional other elements. Some of the elements may be integrated into a single entity that still performs the same functions as those of such elements before integrated.

FIG. 3 is a diagram illustrating a configuration of a tethering group including an electronic device 300, according to an embodiment of the present invention.

Referring to FIG. 3, the tethering group includes the electronic device 300, a plurality of terminals 500 and an auxiliary terminal 400.

The electronic device 300 includes the data transmitting and receiving module 310, the control module 320 and the data flow managing module 330.

The data transmitting and receiving module 310 transmits and receives data according to, for example, a first data flow f1 connected to a first backhaul 1. As used herein, data flow refers to a path or a flow through which data is transmitted when data transmission is performed among terminals 300, 400 and 500 in a tethering group. For example, a data transmission path formed in a sequence of the terminal 500 (or an auxiliary terminal 400), the electronic device 300, the first backhaul 1 and an external network may indicate one data flow (e.g., the first data flow f1). Alternatively, a data transmission path formed in a sequence of the terminal 500, the electronic device 300, the auxiliary terminal 400, a second backhaul 2 and the external network may indicate another data flow (e.g., a second data flow f2). Here, the external network may be a communication network. The communication network may include at least one of a computer network, the Internet, the Internet of things, and a telephone network. The data transmitting and receiving module 310 may include the communication interface 160 shown in FIG. 1 or the communication module 220 shown in FIG. 2.

The control module 320 transfers the data transmitted from the data flow managing module 330 to the data transmitting and receiving module 310, classifies the data transmitted from the data transmitting and receiving module 310 correspondingly to each request of the terminals and transmits the classified data to the data flow managing module 330. When the electronic device 300, the auxiliary terminal 400 and/or terminals 500 request different pieces of data, the control module 320 classifies the data transmitted from the data transmitting and receiving module 310 such that the data requested by the terminals 500 are transferred properly, and then the control module 320 transmits the classified data to the data flow managing module 330. For example, the control module 320 determines whether the data transmitted from the data transmitting and receiving module 310 is data requested from the electronic device 300, data requested from the auxiliary terminal 400 or data requested from the terminal 500. The control module 320 classifies the transmitted data as the data requested from the electronic device 300, the data requested from the auxiliary terminal 400 and the data requested from the terminal 500 and transmits the classified data to the data flow managing module 330.

The data flow managing module 330 monitors a tethering state in the tethering group and determines a data flow according to a monitored result. The data flow managing module 330 selects at least one auxiliary terminal 400 from among the terminals 500 including a second backhaul 2 and generates the second data flow f2 connected to the second backhaul 2. In addition, the data flow managing module 330 configures one of the first data flow f1 and the second data flow f2 according to the data requested from the terminals 300, 400 and 500 and transmits the data. In this case, the terminal 500 selected by the data flow managing module 330 may be configured as the auxiliary terminal 400. That is, after a terminal is selected by the data flow managing module 330, the same terminal may be configured such that the same terminal performs a different function (e.g., a function of the auxiliary terminal 400).

Here, the tethering state includes a data transmission amount during a tethering of the tethering group, a data transmission speed, a network access frequency number, a load amount of the terminal, or a network complexity.

The data flow managing module 330 additionally generates the second data flow f2 when the data transmission amount is higher than a reference value, when the network access frequency number is higher than a reference number, when the load amount of a terminal is higher than a reference value, or when the network complexity is higher than a reference value. Each reference value may be a value set by a user in advance. In addition, each reference value may be changed randomly by the user.

The data flow managing module 330 identifies whether each of the terminals 500 in the tethering group has the second backhaul 2 in order to generate the second data flow f2. The data flow managing module 330 selects at least one terminal having the second backhaul 2 as the auxiliary terminal 400. For example, the data flow managing module 330 selects a terminal which has a load amount that is at least equal to the auxiliary terminal 400 from among the terminals 500 having the second backhaul 2 in the tethering group. The data flow managing module 330 selects a terminal which has a supportable data transmission speed that is as fast as the auxiliary terminal 400 from among the terminals 500 having the second backhaul 2 in the tethering group.

The data flow managing module 330 selects from among the terminals 500 having the second backhaul 2 as the auxiliary terminal 400 according to input information of a user. In this case, the input information of the user may be input through the input/output interface 140 and the input device 250. Here, the input information may be information indicating a preference of the user, such as a load amount of a terminal, a data transmission speed, a size of the data, a network complexity, and the like. In addition, the input information of the user may be information on a direct selection of a specific terminal.

The data flow managing module 330 generates the second data flow f2 where the data of the tethering group is connected to the network through the electronic device 300, the auxiliary terminal 400 and the second backhaul 2 by selecting the auxiliary terminal 400.

The data flow managing module 330 configures data flows corresponding to each piece of data according to a type or a process frequency of the data in the tethering group. For example, the first data flow f1 connected to the network through the first backhaul 1 may be related to game data and the second data flow f2 connected to the network through the second backhaul 2 may be directed to web surfing data. In addition, when a process frequency of the web surfing data is lower than that of the game data, the first data flow f1 may be related to the game data of which the process frequency is high and the second data flow f2 may be related to the web surfing data of which the process frequency is low. In this case, the data flow managing module 330 identifies ID addresses or ports of each piece of the data to detect a type or an object of the data and configures the data flow accordingly. As another example, the data flow managing module 330 configures the first data flow f1 connected to the network through the first backhaul 1 to data related to a voice service (e.g., a voice call and the like) through an IP Multimedia Subsystem (IMS) and configures the second data flow f2 connected to the network through the second backhaul 2 to Internet related data. As another further example, the data flow managing module 330 configures the first data flow f1 connected to the network through the first backhaul 1 to a browser (i.e., Internet) related data and configures the second data flow f2 connected to the network through the second backhaul 2 to a Multimedia Message Service (MMS) related data. In addition, the data flow configured by the data flow managing module 330 may not be limited to the above-mentioned examples, and may be variously changed.

The data flow managing module 330 selects a plurality of terminals from among the terminals 500 having the backhaul of the tethering group as the auxiliary terminals 400. In this case, the data flow managing module 330 generates a plurality of data flows which transmit data to the network through the selected auxiliary terminals 400 and each backhaul of the auxiliary terminals 400. In this case, the data flow managing module 330 generates a routing table for the plurality of data flows to configure data flows through which each piece of the data are transmitted to the network.

The data flow managing module 330 requests a generation of the second backhaul to at least one terminal, which does not have a backhaul among the terminals 500 in the tethering group. In this case, the terminal 500 receiving the request of the generation of the backhaul generates the second backhaul 2 and notifies the generation of the second backhaul 2 to the electronic device 300. In addition, the terminal 5 generating the second backhaul transmits information including a load amount and a supportable speed of the terminal to the electronic device 300.

The data flow managing module 330 selects the terminal 500 generating the second backhaul as the auxiliary terminal 400 and generates the second data flow f2. That is, the terminal 500 selected by the electronic device 300 from among the terminals 500 generating or having the second backhaul 2 may be the auxiliary terminal 400.

The electronic device 300 may configure and managea data flow, differently, according to requests from each terminal in the tethering group in consideration of speed and traffic of a plurality of backhauls in the tethering group. For example, if a main object of the tethering group is a game or a video conference of which a traffic request amount is large and a fast data transmission is requested, the electronic device 300 directly measures data transmission speeds or load amounts of the first backhaul 1 connected thereto and the second backhual 2 of the auxiliary terminal 400 and/or receives information on the data transmission speeds or the load amounts from the auxiliary terminal 400. Here, when the first backhaul 1 supports a data transmission speed faster than that of the second backhaul 2, the electronic device 300 transmits data through the first data flow f1, which is through the first backhaul 1 in response to the data request for the gate (or the video conference or the like), and which is the main object from the electronic device 300, the auxiliary terminal 400 and the terminal 500. In contrast, the electronic device 300 transmits data through the second data flow f2, which is through the second backhaul, in response to the data request for another object (e.g., a web surfing, Internet (browser) search, an MMS sending and the like) except for the game (or a case of information requesting a large traffic such as the video conference).

In this case, for example, according to a path where the data is transmitted through the first data flow f1, the electronic device 300 transmits the data requested therefrom through the first backhaul 1, which is directly connected thereto. In addition, in the case of the auxiliary terminal 400 and the terminal 500, the electronic device 300 transmits the data through the first data flow f1, which is through the electronic device 300 and the first backhaul 1.

In addition, for example, according to a path where the data is transmitted through the second data flow f2, the electronic device 300 transmits the data through the auxiliary terminal 400 and the second backhaul 2. The terminal 500 transmits the data through the second data flow f2, which is through the electronic device 300, the auxiliary terminal 400 and the second backhaul 2. In this case, after the auxiliary terminal 400 transmits the data to the electronic device 300, the auxiliary terminal 400 transmits the data through the auxiliary terminal 400 and the second backhaul 2, under a control of the electronic device 300, or directly transmits the data through the second backhaul 2.

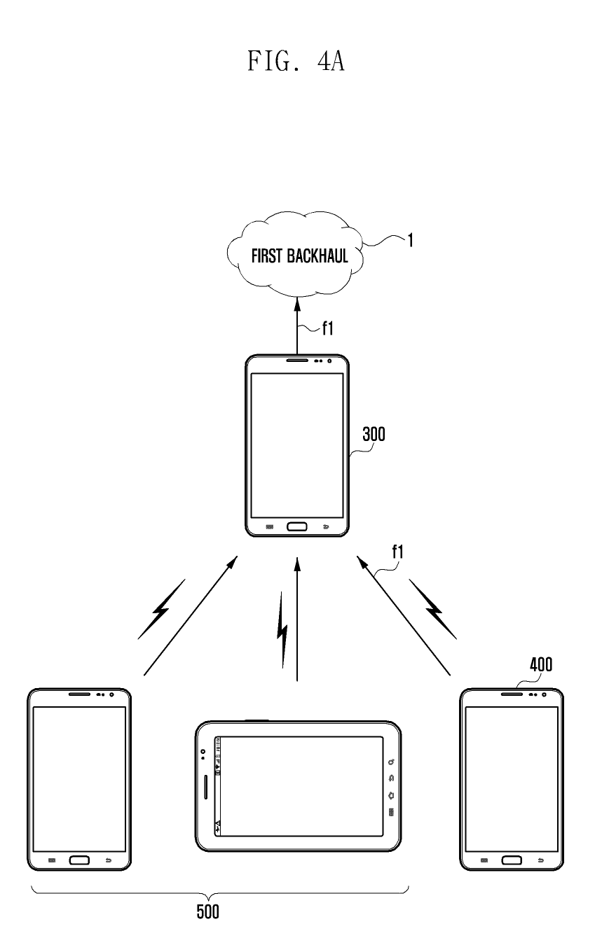

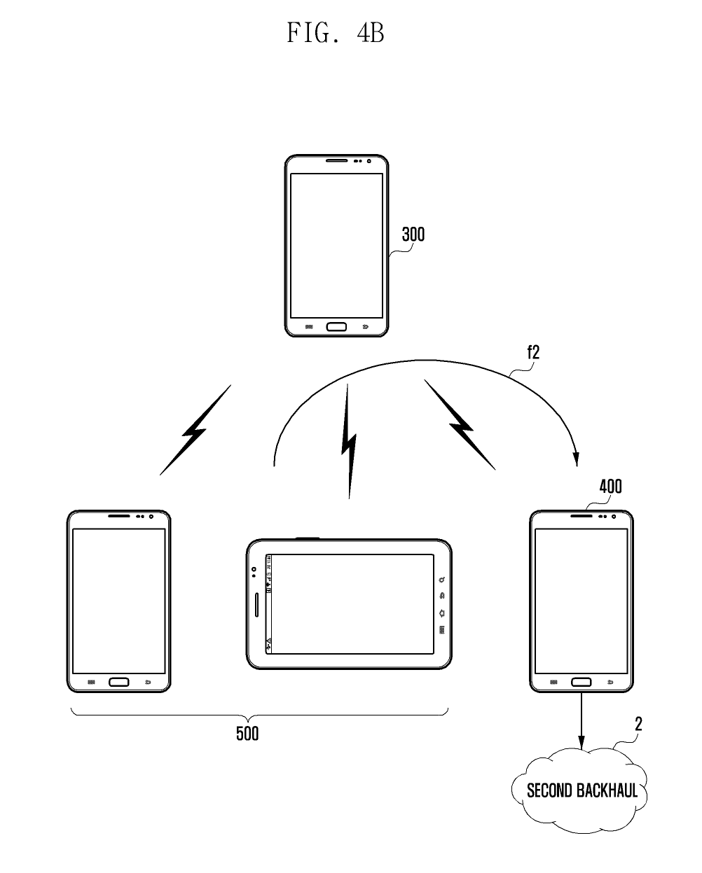

FIG. 4A and FIG. 4B are diagrams illustrating an operation of an electronic device, according to an embodiment of the present invention. In FIG. 4A and FIG. 4B, each terminal 500 represents a terminal in one tethering group, and the directional arrow indicates a first data flow f1. Here, the number of terminals 500 in the tethering group may not be limited to the case of FIG. 4A and FIG. 4B and may be changed. That is, more or less than two terminals may be included in the tethering group.

FIG. 4A is a view illustrating a first data flow f1 in a method of managing a data flow in a tethering, according to an embodiment of the present invention. Referring to FIG. 4A, data output from three terminals may be collected at the electronic device 300 and may be transmitted to an external network. Data received from the external network may be transmitted to the terminals 400 or 500 through a first backhaul 1 and the electronic device 300.

FIG. 4B is a view illustrating a second data flow f2 in a method of managing a data flow in a tethering, according to an embodiment of the present invention. Referring to FIG. 4B, data output from a middle terminal among three terminals 500 may be transmitted to an external network through the second data flow f2, which is through a second backhaul 2 without using a first backhaul. Data requested from the terminals 300, 400 and 500 in the tethering group may be transmitted to the external network through the second data flow f2, which is through the auxiliary terminal 400 and the second backhaul 2. Data received from the external network may be transmitted to the terminals 300, 400 and 500 sequentially through the second backhaul 2, the auxiliary terminal 400 and the electronic device 300.

The first data flow f1 and the second data flow f2 shown in FIG. 4A and FIG. 4B may be simultaneously generated. The data flow managing module 330 of the electronic device 300 classifies data in the tethering group and configures each piece of the data to the first data flow f1 and the second data flow f2 to transmit the data to a network. For example, when the tethering group is formed in relation to an online game, data for the online game may be transmitted to the network through the first data flow f1. Data for another object (e.g., an Internet search and the like), except for the data for the game, may be simultaneously transmitted to the network through the second data flow f2. As another example, when the tethering group is formed in relation to an Internet (browser) search, data related to the Internet search may be transmitted to the network through the first data flow f1. Data (e.g., data for an MMS transmission), except for the data for the Internet search, may be simultaneously transmitted to the network through the second data flow f2. That is, data for a main object may be transmitted through the first data flow f1 and subsidiary data may be transmitted through the second data flow f2, according to the main object of the tethering group.

The data transmitting and receiving module 310 of the electronic device transmits and receives data to and from an external network according to a first data flow f1 connected to a first backhaul 1. The control module 320 transfers data transmitted from the data flow managing module 330 to the data transmitting and receiving unit 310, classifies the data transmitted from the data transmitting and receiving module 310 according to requests of each of terminals 400 and 500 and transmits the classified data to the data flow managing module 330. The data flow managing module 330 monitors a tethering state in a tethering group, selects an auxiliary terminal 400 including a second backhaul 2 according to a monitored result to generate a second data flow f2 connected to the second backhaul 2 and configures one of the first data flow f1 and the second data flow f2 according to data requested by the terminals 400 and 500 to transmit data.

Here, the data flow managing module 330 determines if the data flow managing module 330 has added the second data flow f2 when a load amount of a terminal is equal to or higher than a reference value according to the monitored tethering state.

The data flow managing module 330 selects a terminal which has a load amount that is at least equal to a load amount of the auxiliary terminal 400 from among the terminals 500 including the second backhaul 2 in the tethering group. In addition, the data flow managing module 330 selects a terminal that has a supportable data transmission speed that is at least equal to a data transmission speed of the auxiliary terminal 400 from among the terminals 500 including the second backhaul 2 in the tethering group.

The data flow managing module 330 selectively selects the first data flow f1 or the second data flow f2 according to a type of the data requested by the terminals 400 and 500 in the tethering group.

The data flow managing module 330 of the electronic device 300 requests a generation of the second backhaul for at least one terminal which does not include a backhaul from among the terminals 500 in the tethering group, and selects a terminal which generates the second backhaul 2, as the auxiliary terminal, to generate the second data flow f2 when the second backhaul is generated.

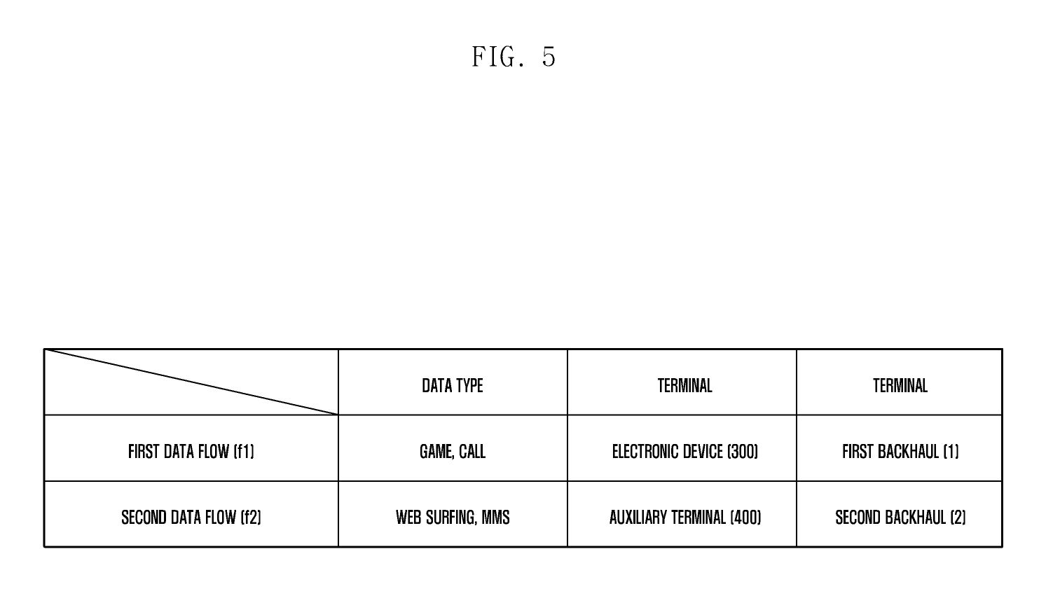

FIG. 5 is a diagram illustrating a table for configuring a data flow, according to an embodiment of the present invention.

Referring to FIG. 5, the electronic device 300 stores a table including information on types of data corresponding to each data flow, a terminal and backhauls in a data transmission path of a corresponding data flow.

The types of the data corresponding to each data flow may be configured differently by a user or a predetermined condition. As illustrated in FIG. 5, game data, of which has a traffic request amount that is large, uses a first data flow f1 and another type of data is used by a second data flow f2, under an assumption that a data transmission speed supported by a first backhaul 1 is faster than a data transmission speed of a second backhaul, but the present invention is not so limited.

Continuing with reference to FIG. 5, the first data flow f1 may be a path where data is transmitted through the electronic device 300 and the first backhaul 1 included in the electronic device 300. In addition, the second data flow f2 may be a path where data is transmitted through an auxiliary terminal 400 and a second backhaul 2 included in the auxiliary terminal 400. In this case, the terminal and the backhaul included in the first data flow f1 and the second data flow f2 may be changed according to a configuration of a user. In addition, FIG. 5 shows a data flow table using a name of a terminal and a name of a backhaul, but the electronic device 300 may generate and store a table which includes IP addresses of each terminal and backhaul, and may generate and store a unique identification number (e.g., an ID and the like), which may be mapped, or a data flow managing table of a routing table form.

In addition, when the electronic device 300 generates and configures an additional data flow, except for the first data flow f1 and the second data flow f2, mapping information on all data flows may be generated and stored in the table form shown in FIG. 5.

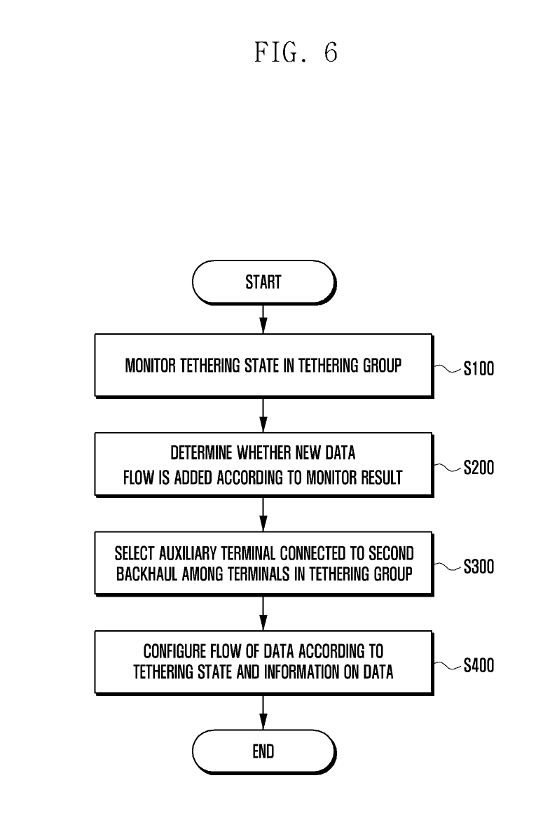

FIG. 6 is a flowchart illustrating a method of a managing a data flow in a tethering group, according to an embodiment of the present invention.

At step S100, a tethering state using a first data flow f1 connected to the first backhaul 1 in the tethering group is monitored.

The tethering group may include an electronic device 300, which provides a tethering function to the tethering group using the first backhaul 1 and a plurality of terminals 500 connected to the electronic device 300. The plurality of terminals 500 may be connected to an external network through the electronic device 300. The first backhaul 1 may include a 3^{rd} Generation Partnership Project (3GPP) network including a cellular network or a non-3^{rd} Generation Partnership Project (non-3GPP) including Wi-Fi and WiMax, as a network connected to the electronic device 300. In addition, the first backhaul 1 may be connected to another external network.

The first data flow f1 may be a path through which each piece of data requested from each terminal 500 in the tethering group is connected to the external network. In addition, the first data flow f1 may refer to a Public Data Network (PDN) or an IP flow. Specifically, the data requested from the terminals 500 may be transmitted to the external network through the electronic device 300 and the first backhaul 1. The first data flow 1 indicates a path where the data is connected to the external network through the first backhaul 1.

The tethering state includes a data transmission amount during a tethering of the tethering group, a data transmission speed, a network access frequency number, a load amount of the electronic device 300 and a network complexity. The load amount of the electronic device 300 includes a CPU possession rate and a memory use amount of the electronic device 300.

At step S200, the electronic device 300 may determine whether the electronic device 300 adds a new data flow according to the tethering state. Specifically, at step S200, when the load amount of the electronic device 300 is equal to or higher than a reference value, the electronic device 300 determines an addition of the new data flow. The load amount of the electronic device 300 includes a CPU possession rate and a memory use amount. The reference value may be a predetermined value by a user for a smooth operation of the electronic device 300. In addition, the reference value may be randomly changed by the user.

In addition, at step S200 when a data transmission speed becomes lower, and thus an effect required by a user is not generated, the electronic device 300 determines the addition of the new flow. For example, when a main object of the tethering group is playing a game by a connection through a network between a plurality of terminals 500, the game may not be performed smoothly in each of the plurality of terminals 500 because a data transmission speed for a smooth performance of the game is not satisfied. As another example, when a main object of the tethering group is an IMS related service, the EMS service (e.g., a voice call), which is the main object, may not be performed smoothly, and thus a call may be disconnected. That is, when a function corresponding to the main object of the tethering group is not performed smoothly, the electronic device 300 may add a data flow connected to an external network through the second backhaul 2 of the auxiliary terminal 400 to allot a part of the load charged to the electronic device 300 and stabilize a network.

At step S300, the auxiliary terminal 400 having the second backhaul 2 from among at least one terminal 500 in the tethering group may be selected and the second data flow f2 connected to the second backhaul 2 may be generated. Specifically, the electronic device 300 selects at least one terminal 500 as the auxiliary terminal 400 from among the terminals 500 having the second backhaul 2 in the tethering group.

The second backhaul 2 considers a backhaul included in the auxiliary terminal 400. The second backhaul 2 may include a 3GPP network or a non-3GPP. In addition, the second backhaul 2 may be connected to other external networks.

At step S300, the electronic device 300 selects the auxiliary terminal 400, and thus the second data flow f2, where a portion of the data processed in the tethering group is connected to the external network through the auxiliary terminal 400 and the second backhaul 2, may be generated.

At step S400, each piece of the data may be configured to any of the first data flow f1 and the second data flow f2 according to the tethering state and a state of the data. Specifically, the electronic device 300 configures each piece of data requested from the terminals (e.g., the electronic device 300, the auxiliary terminal 400 and the terminal 500) in the tethering group to any of the first data flow f1 and the second data flow f2 for transmitting each piece of the data to the external network through the configured data flow.

The state of the data may indicate a type of data according to a service requested from the terminals 300, 400 or 500. In addition, the state of the data may be IP address information or port information of the data requested from the terminals 300, 400 and 500.

For example, the type of the data may be classified as data necessary in driving a game and data for Internet or web surfing. The electronic device 300 transmits the data necessary for driving the game through the first data flow f1, thereby being connected to the network using the first backhaul 1, and transmits the data for Internet or the web surfing through the second data flow f2, thereby being connected to the network using the second backhaul 2 of the auxiliary terminal 400.

In addition, the type of the data may be classified by the address and the port of the data. Thus, at step S400, the electronic device 300 transmits pieces of the data in which the IP addresses and the ports are the same through the same data flow.

Alternatively, at step 400, the electronic device 300 configures data flow of each piece of the data by comparing a size of the data processed in the tethering group with a reference data transmission amount of the first backhaul 1 and a reference data transmission amount of the second backhaul 2. For example, when the pieces of the data processed in the tethering group are data for a game and data for Internet, the size and the traffic of the data for the game may be larger than those of the data for Internet. When the reference data transmission amount of the first backhaul 1 is larger than that of the second backhaul 2, the electronic device 300 transmits the data for the game through the first data flow f1 using the first backhaul 1 and transmits the data for Internet through the second data flow f2. The types of the pieces of the data processed in the tethering group may be variously changed except for the data for the game and the data for Internet. The electronic device 300 may configure the data flow for a more smooth data transmission differently by comparing comparative size and traffic of the data processed in the tethering group.

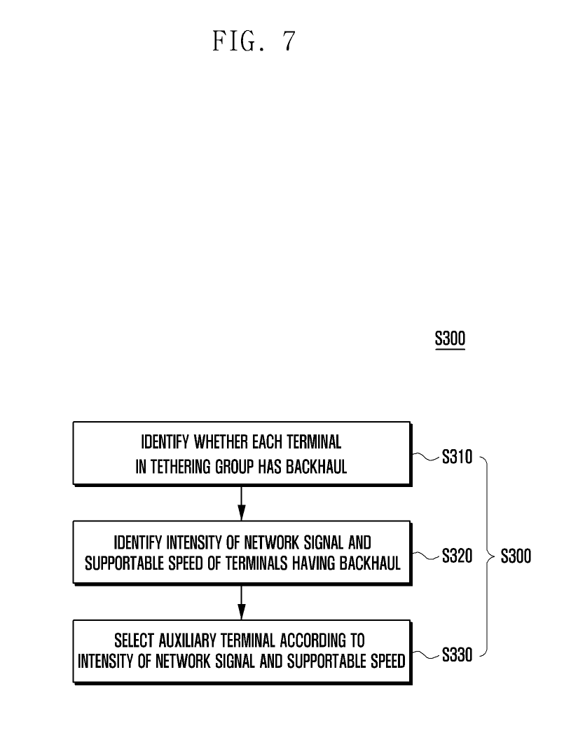

FIG. 7 is a flowchart illustrating an operation of adding a data flow in a method of managing a data flow, according to an embodiment of the present invention.

At step S310 the electronic device 300 identifies whether each of the terminals 500 in the tethering group has the second backhaul 2. Specifically, the terminal 500 may autonomously have another backhaul (i.e., the second backhaul 2) besides the first backhaul 1 connected to the electronic device 300, from among the terminals 500 in the tethering group. At step S310 the electronic device 300 receives information on each of the terminals 500 to identify whether each of the terminals has the second backhaul 2.

At step S320, the electronic device 300 identifies an intensity of a network signal and a supportable speed of each terminal 500 having the second backhaul 2. The intensity of the network signal may be an intensity (e.g., an intensity of a signal from a network of communication company) of a signal from an external network to the terminals 500 having the backhaul. In addition, at step S320 the electronic device 300 identifies each load amount (e.g., a CPU possession rate and a memory use amount) of the terminals 500 having the backhaul.

At step S330, the electronic device 300 selects at least one terminal as the auxiliary terminal 400 from among the terminals 500 having the second backhaul 2, according to the intensity of the network signal and the supportable speed, and generates the second data flow f2. The electronic device 300 also selects a plurality of auxiliary terminals 400. Thus, a plurality of data flows connected to different backhauls through the plurality of auxiliary terminals 400 may be additionally generated.

Specifically, at step S330, the electronic device 300 selects a terminal which has a supportable data transmission speed that is at least as fast as the auxiliary terminal 400 from among the terminals 500 having the second backhaul 2.

In addition, at step S330, the electronic device 300 selects a terminal which has a load amount that is as least equal to a load amount of the auxiliary terminal 400 from among the terminals 500 having the second backhaul 2.

At step S330, the electronic device 300 selects the auxiliary terminal 400 from among the terminals 500 having the second backhaul 2, according to input information of a user.

The input information may be information indicating a preference of the user, including but not limited to a data transmission speed, a load amount of the terminal, and the size of data. This input information is considered by the electronic device when configuring the data flow. The input information of the user may be input through the input/output interface 140 or the input device 250 of the electronic device 300.

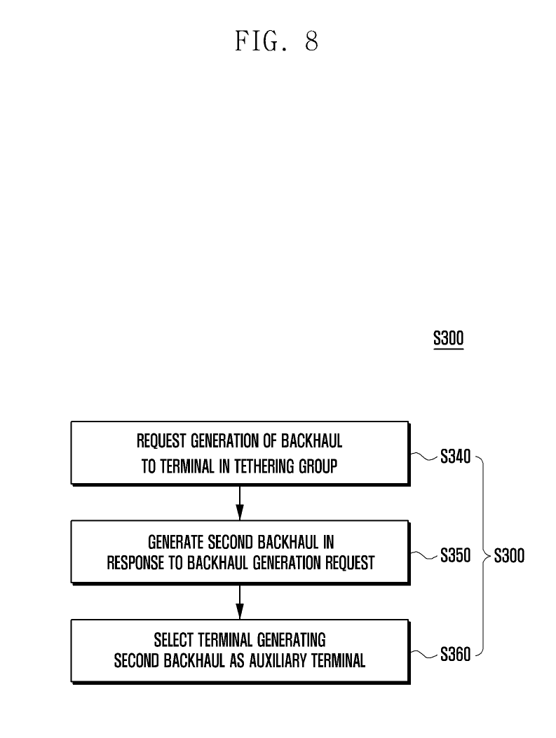

FIG. 8 is a flowchart illustrating an operation of adding the data flow in the method of managing the data flow, according to an embodiment of the present invention.

At step S340, before the electronic device 300 selects the auxiliary terminal 400, the electronic device 300 requests a backhaul generation from at least one terminal from among the terminals 500 in the tethering group. Specifically, the tethering group may include the terminal 500, which can generate the backhaul. The electronic device 300 requests the backhaul generation from at least one terminal from among the terminals 500, which do not include the backhaul in the tethering group. The terminal receiving the backhaul generation generates the second backhaul 2 in response to the request. On the contrary, when the electronic device 300 requests a backhaul release from the terminal (e.g., the auxiliary terminal 400) having the backhaul, the auxiliary terminal 400 releases the second backhaul 2 and a previously configured second data flow f2.

At step S350, the terminal 500 receiving the request of the backhaul generation generates the second backhaul 2 connected to an external network. The terminal 500 generating the second backhaul 2 notifies the electronic device 300 of the generation of the second backhaul 2. At step S350, the electronic device 300 receives information on a generation-or-not of the second backhaul 2, a load amount and a supportable speed of the terminal from the terminal 500, which generates the second backhaul.

At step S360, the electronic device 300 selects the terminal 500 generating the second backhaul as the auxiliary terminal 400 and generates the second data flow f2 connected to the second backhaul.

The method of FIG. 8 may also include the step S100 of FIG. 6 that monitors a tethering state using a first data flow f1 connected to a first backhaul 1 in a tethering group, the step S200 of FIG. 6 that determines whether a new data flow is added according to the tethering state, the step S300 of FIG. 6 that selects an auxiliary terminal 400 including a second backhaul 2 among one or more terminals 500 in the tethering group and generates a second data flow f2 connected to the second backhaul 2, and the step S400 of FIG. 6 that configures one of the first data flow f1 and the second data flow f2 to each piece of data according to the tethering state and a state of the data.

Here, the tethering state may include at least one of a data transmission amount during a tethering of the tethering group, a data transmission speed, a network access frequency number, a load amount of the electronic device, and a network complexity.

Here, the first backhaul 1 and the second backhaul 2 may be at least one of a 3GPP network and a non-3GPP, i.e., by including a cellular network, Wi-Fi and WiMax.

At step S200, it may be determined that the data flow is added when a load amount of the electronic device 300 is equal to or higher than a reference value.

The step S300 may include the step S310 of FIG. 7 that identifies whether each terminal 500 in the tethering group includes the second backhaul, the step S320 FIG. 7 that identifies an intensity of a network signal and a supportable speed of each terminal including the backhaul, and the step S330 FIG. 7 that selects at least one terminal as the auxiliary terminal 400 from among the terminals 500 including the second backhaul 2 according to an intensity of the network signal and the supportable speed and generates the second data flow f2.

In this case, at step S330, a terminal which supports a data transmission speed that is faster than any other terminal in the tethering group may be selected as the auxiliary terminal 400 from among the terminals 500 including the second backhaul 2. Alternatively, at step S330, a terminal which has a load amount that is equal to at least a load amount of the auxiliary terminal 400 from among the terminals 500 including the second backhaul 2 may be selected as the auxiliary terminal 400. In addition, at step S330, the auxiliary terminal may be selected from among the terminals 500 including the second backhaul 2 according to input information of a user. In this case, the input information may be received through the input device 250.

At step S330,a terminal including a non-3GPP network may be selected as the auxiliary terminal 400 when data of a service in which a real time or repetitive data transmission occurs based on a network access frequency number is processed.

At step S400, data flows of each piece of the data may be configured by comparing a size of data processed in the tethering group with a reference data transmission amount of the first backhaul 1 and a reference data transmission amount of the second backhaul 2.

Here, at step S400, the first data flow f1 or the second data flow f2 may be configured according to an IP address and a port of data requested from terminals 300, 400 and 500 in the tethering group.

The method of FIG. 8 may further include requesting a backhaul generation for at least one terminal from among the terminals 500 in the tethering group by the electronic device 300 and generating the second backhaul in response to the request by a terminal receiving the requesting of the backhaul generation. In this case, at step S300 of FIG. 6, the electronic device 300 selects the terminal which generates the second backhaul 2 as the auxiliary terminal 400 and generates the second data flow f2 connected to the second backhaul 2.

The above-discussed method is described herein with reference to flowchart illustrations of user interfaces, methods, and computer program products according to embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

While the present invention has been shown and described with reference to certain embodiments thereof, it should be understood by those skilled in the art that many variations and modifications of the method and apparatus described herein will still fall within the spirit and scope of the present invention as defined in the appended claims and their equivalents.

What is claimed is:

1. A method of managing a data flow in an electronic device, the method comprising:
monitoring a tethering including monitoring a tethering state using a first data flow connected to a first backhaul in a tethering group;
determining whether a new data flow is added according to the monitored tethering state;
selecting an auxiliary terminal including a second backhaul from among one or more terminals in the tethering group and generating a second data flow connected to the second backhaul; and
configuring one of the first data flow and the second data flow according to the tethering state and a state of data that is to be transmitted through one of the first data flow and the second data flow.

2. The method of claim 1, wherein monitoring the tethering state comprises monitoring at least one of a data transmission amount during the tethering of the tethering group, a data transmission speed, a network access frequency number, a load amount of the electronic device, and a network complexity.

3. The method of claim 1, wherein the first backhaul and the second backhaul are at least one of a 3^{rd} Generation Partnership Project (3GPP) network including a cellular network and a non-3^{rd} Generation Partnership Project (non-3GPP) including Wi-Fi and WiMax.

4. The method of claim 1, wherein determining whether the new data flow is added comprises determining when a load amount of the electronic device is equal to or greater than a reference value.

5. The method of claim 1, wherein determining whether the new data flow is added comprises:
identifying whether each terminal in the tethering group includes the second backhaul;
identifying an intensity of a network signal and a supportable speed of each terminal including the second backhaul; and
selecting at least one terminal as the auxiliary terminal from among terminals including the second backhaul, according to the intensity of the network signal and the supportable speed, and generating the second data flow.

6. The method of claim 5, wherein selecting the at least one terminal as the auxiliary terminal comprises selecting at least one terminal which has a supportable data transmission speed that is as fast as the auxiliary terminal from among the terminals including the second backhaul.

7. The method of claim 5, wherein selecting the at least one terminal as the auxiliary terminal comprises selecting at least one terminal which has a load amount that is at least equal to a load amount of the auxiliary terminal from among the terminals including the second backhaul.

8. The method of claim 5, wherein selecting the at least one auxiliary terminal from among the terminals including the second backhaul is based on input information of a user.

9. The method of claim 5, wherein selecting the at least one auxiliary terminal from among the terminals comprises selecting a terminal including a non-3GPP network as the second backhaul when data of a service in which one of a real time and repetitive data transmission occurs based on a network access frequency number is processed.

10. The method of claim 1, wherein configuring one of the first data flow and second data flow comprises comparing a size of data processed in the tethering group with a reference data transmission amount of the first backhaul and a reference data transmission amount of the second backhaul, and configuring the data that is to be transmitted through one of the first data flow and the second data flow based on the comparison.

11. The method of claim 1, wherein configuring one of the first data flow and second data flow comprises configuring one of the first data flow and the second data flow according to an IP address and a port of data requested from the terminals in the tethering group.

12. The method of claim 1, further comprising:
requesting, by the electronic device, a backhaul generation to at least one terminal from among the terminals in the tethering group; and
generating, by a terminal receiving the request of the backhaul generation, the second backhaul in response to the request.

13. The method of claim 12, wherein selecting an auxiliary terminal including a second backhaul comprises selecting, by the electronic device, the terminal which generates the second backhaul as the auxiliary terminal and generating the second data flow connected to the second backhaul.

14. An electronic device comprising:
a data transmitting and receiving module that transmits and receives data to and from an external network according to a first data flow connected to a first backhaul; and
a control module that transfers data transmitted from a data flow managing module to the data transmitting and receiving module, classifies the data transmitted from the data transmitting and receiving module according to requests by each terminal in a tethering group and transmits the classified data to the data flow managing module,
wherein the data flow managing module monitors a tethering state in the tethering group, selects an auxiliary terminal including a second backhaul according to a monitored result of the tethering state to generate a second data flow connected to the second backhaul, and configures one of the first data flow and the second data flow according to the tethering state and a state of data that is to be transmitted through one of the first data flow and the second data flow.

15. The electronic device of claim 14, wherein the data flow managing module adds the second data flow when a load amount of a terminal is equal to or greater than a reference value of the monitored tethering state.

16. The electronic device of claim 14, wherein the data flow managing module selects a terminal which has a load amount that is at least equal to a load amount of the auxiliary terminal from among the terminals including the second backhaul in the tethering group.

17. The electronic device of claim 14, wherein the data flow managing module selects a terminal which has a supportable data transmission speed that is at least as fast as the auxiliary terminal from among the terminals including the second backhaul in the tethering group.

18. The electronic device of claim 14, wherein the data flow managing module selectively selects one of the first data flow and the second data flow according to a type of data requested by the terminals in the tethering group.

19. The electronic device of claim 14, wherein the data flow managing module requests a generation of the second backhaul to at least one terminal which does not include a backhaul from among the terminals in the tethering group, and selects a terminal which generates the second backhaul as the auxiliary terminal to generate the second data flow when the second backhaul is generated.

20. A computer readable recording medium in which at least one program including instructions for performing a method of managing a data flow is recorded, the method comprising:
monitoring a tethering including monitoring a tethering state using a first data flow connected to a first backhaul in a tethering group;
determining whether a new data flow is added according to the monitored tethering state;
selecting an auxiliary terminal including a second backhaul from among one or more terminals in the tethering group and generating a second data flow connected to the second backhaul; and
configuring one of the first data flow and the second data flow according to the tethering state and a state of data that is to be transmitted through one of the first data flow and the second data flow.
